(19) United States
(12) Patent Application Publication
(10) Pub. No.: US 2010/0035475 A1
(43) Pub. Date: Feb. 11, 2010

(54) SIM Card Connector

(75) Inventors: Yin-Lung Wu, Taipei Hsien (TW); Ming-Chiang Chen, Taipei Hsien (TW)

Correspondence Address: WPAT, PC;INTELLECTUAL PROPERTY ATTORNEYS, 2030 MAIN STREET, SUITE 1300, IRVINE, CA, 92614, US

(73) Assignee: CHENG UEI PRECISION INDUSTRY CO., LTD., Taipei Hsien (TW)

(21) Appl. No.: 12/603,327

(22) Filed: Oct. 21, 2009

(30) Foreign Application Priority Data
Oct. 13, 2006 (TW) 095218118

(51) Int. Cl. H01R 24/00

(52) U.S. Cl. 439/630

(57) ABSTRACT

A SIM card connector comprises: a dielectric housing, having a plurality of terminals and a push cam means inside, and a cover outside of the dielectric housing. Therein the push cam means consists of a plurality of sliding blocks and springs, and one end of the spring is hitched on the dielectric housing, and the other end fastened on the sliding block; the sliding block has a base portion whose sinciput forms a pushing portion; the cover has a top plate, and two clasps are set at the back end of the top plate, in the middle part of the top plate there set two recesses. As to draw the SIM card out of the SIM card connector, it is needed to press the card from through the two recesses and makes it divorced from the clasps. Under the force of the springs, the sliding blocks then drive the SIM card out of the SIM card connector.

### CROSS-REFERENCE TO RELATED APPLICATIONS

This application claims foreign priority to Taiwan patent application number 095218118, filed on Oct. 13, 2006, which is hereby incorporated by reference in its entirety.

### BACKGROUND OF THE INVENTION

1. Field of the Invention

This invention relates to a SIM (Subscriber Identify Module) card connector assembly.

2. The Related Art

With the rapid development of science and technology in the modern world, the mobile phone has become an indispensable part in people's life. Since being light and portable, it is easy to take and use, which makes it possible to communicate with the person far away and benefit people's life greatly. In a common GSM (Global System for Mobile communications), when the user applies for a mobile phone number, simultaneously he/she will get a SIM card corresponding with that number. This SIM card is set in the mobile phone to identify the user that is important for dialing and timing. Besides, as a micro-process chip, it provides a memory to record the related information such as phone numbers or others.

A present SIM card connector generally includes a housing, with a plurality of terminals inside and a cover outside of the housing, which forming a container space to receive the SIM card.

However, the SIM card and SIM card connector mentioned above take up only a small space in the mobile phone. When the SIM card plugs into the connector, it is hard to extract the card. If it is drew out too forcibly, the SIM card may get damaged easily. At present there are cases that adding mechanisms to help with withdrawing the SIM card, but it always has to offer an impetus, which might be dangerous to the card. And, that mechanism usually is set at the exterior or the both sides of the connector, which makes the connector larger and not suitable for using inside of the mobile phone.

### SUMMARY OF THE INVENTION

In order to conquer the disadvantages mentioned above, a SIM card connector which has a push cam means is provided. The SIM card connector includes a dielectric housing, a plurality of terminals, push cam means and a cover. The dielectric housing has a base plate. A rear wall and two sidewalls extend upwards from the back portion and both sides of the base plate respectively. The base plate, the rear wall and the two sidewalls form a receiving cavity to receive a SIM card. Pluralities of terminal pores are defined on the base plate. Pair of sliding grooves is defined on the base plate. The said terminals are received in the terminal pores respectively. The push cam means includes a pair of sliding blocks and springs. The sliding blocks and the springs are received in the sliding grooves. Each sliding block has a base portion. A pushing portion is defined on the back of each sliding blocks. The cover has a top plate. A pair of clasps is defined on the back end of the top plate. A pair of recesses is formed on the top plate. When the SIM card is inserted into the receiving cavity, the front end of the SIM card pushes the pushing portion of the sliding blocks and the back end of the SIM card compresses against the clasps. When the SIM card is needed to be removed out of the receiving cavity, it will be removed by pressing the SIM card through the recesses and making the end of the SIM card getting off the clasps, then the sliding blocks will push the SIM card out by an elastic force supplied by the springs.

### BRIEF DESCRIPTION OF THE DRAWINGS

A detailed explanation of a preferred embodiment of the present invention will be given, with reference to the attached drawings, for better understanding thereof to those skilled in the art:

FIG. 1 is an exploded view of a connector in accordance with the present invention;

FIG. 2 is a perspective view of a push cam means of the connector in accordance with the present invention;

FIG. 3 is another perspective view of a push cam means of the connector in accordance with the present invention;

FIG. 4 is a perspective view of a dielectric housing of the connector in accordance with the present invention;

FIG. 5 is a perspective view of the interior of the connector in accordance with the present invention;

FIG. 6 is a perspective view of the connector in accordance with the present invention;

FIG. 7 is a cross-sectional view of the connector along VII-VII in FIG. 6;

FIG. 8 is another perspective view of the connector in accordance with the present invention; and

FIG. 9 is a cross-sectional view of the connector along IX-IX in FIG. 8.

### DETAILED DESCRIPTION OF THE PREFERRED EMBODIMENT

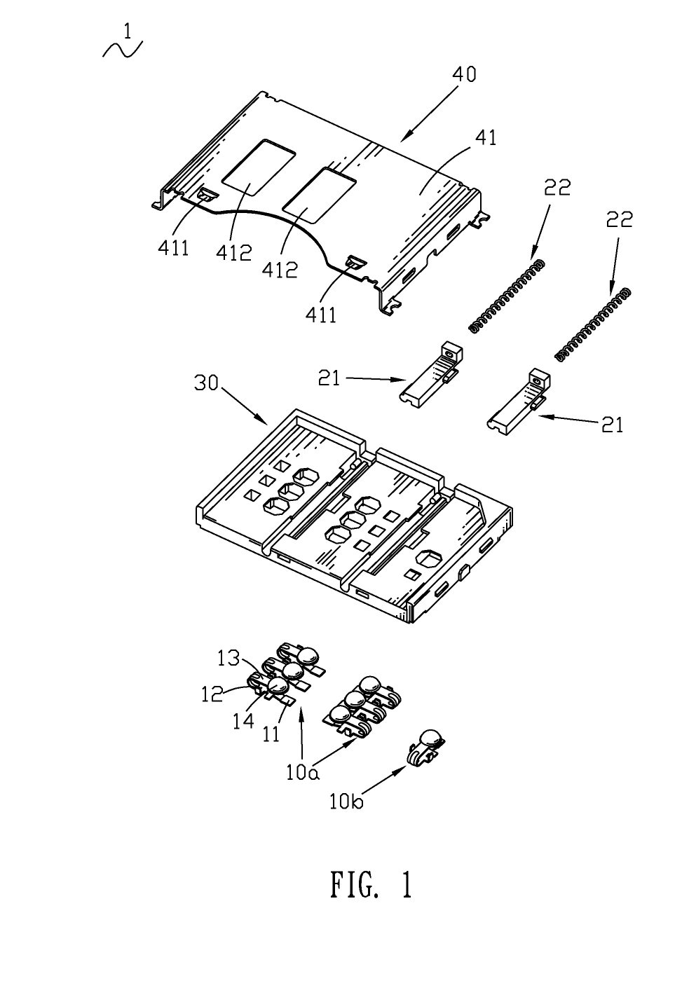

Referring to FIG. 1, a SIM card connector 1 according to the present invention comprises: a dielectric housing 30 having a plurality of terminals 10a and a holding terminal 10b and a push cam means inside. The push cam means consists of a pair of gliders 21 and springs 22. A metal cover 40 shelters the dielectric housing 30 to form a receiving cavity to receive a SIM card 50 therein (as shown in FIGS. 7 and 9).

Referring to FIG. 1 again, each of the terminals 10a contains an installing portion 12 to be fixed into the housing 30. At its right end the installing portion 12 bends rightwards horizontally and forms a soldier portion 11 to mount the terminal 10a onto the PC board (not shown). The left end of the installing part 12 bents rightwards to form a flexible portion 13, and at the right end of each terminal 10 it formed a contact portion 14 extending outward beyond the surface of the base plate 31.

The fixing terminal 10b has the same structure with these terminals 10a. But in implement it should not be limited in that structure. Any other structure will work as long as to uphold the SIM card 50 inserted into the SIM card connector 1.

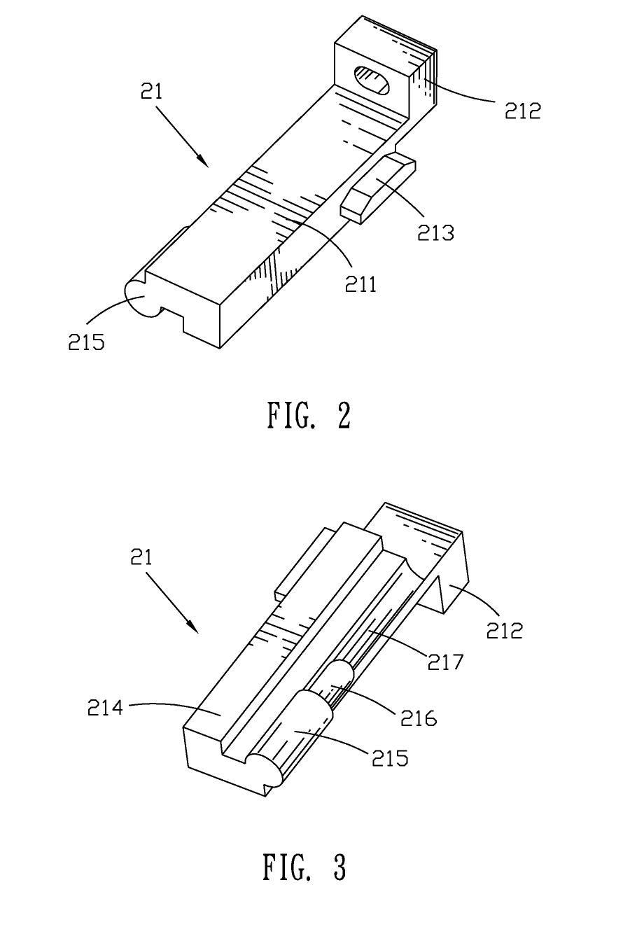

With reference to FIGS. 2 and 3, a sliding block 21 of the push cam means includes a base portion 211, whose sinciput bends and stretches upwards to form a pushing portion 212. And at the button of its one side, the base portion 211 protrudes a guiding portion 213 horizontally leveling with the bottom surface of the base portion 211. At the same side, the sliding block 21 protrudes downwards and forms a batten-like main body 214 expanding lengthways. On the other side, at the bottom of the back part, the base portion 211 protrudes outwards and downwards and forms a columniform projection portion 215. On the end of the projection 215 it outspreads a second positional pillar 216. Besides, at the bottom of the second positional pillar 216 it forms an arc 217 which is set along with the second positional pillar 216 to provide a clearance for the spring 22 said above

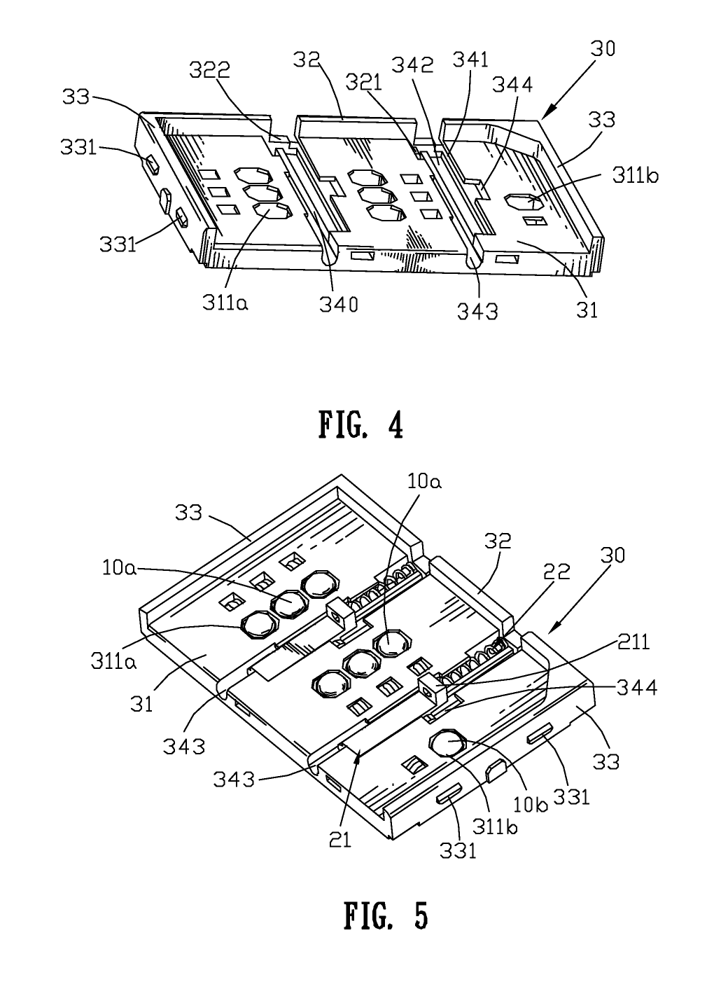

Please referring to FIG. 4, a dielectric housing 30 has a base plate 31, whose front end and both sides extend upwards and form a rear wall 32 and two sidewalls 33. The rear wall 32, sidewalls 33 and the base plate 31 together form a receiving cavity to contain a SIM card. On the ektexine of each sidewall 33 it protrudes an installing block 331 on each end. A plurality of terminal pores 311a are defined on the base plate 31 to receive these terminals 10a therein, and a fixing pore 311b on the opposite side of the base plate 31 to receive the said fixing terminal 10b therein.

Two straight guiding grooves 340 are defined on the base plate 31 too. Each of the straight guiding grooves 340 parallels with the sidewall 33 and extends longitudinally to the rear wall 32 at one end. Beside the straight guiding groove 340, a longitudinally-extended first sliding groove 341 is defined in the body of the base plate 31; and at the top of its middle part, the first sliding groove 341 forms a second slot 344 running through the surface of the base plate 31. At the same side of the straight guiding groove 340, a second sliding groove 342 is set downwards into the base plate 31 between the two grooves mentioned above. At the other side of the straight groove 340, it forms a sunken third groove 343 in the base plate 31 that located beside the bottom of the straight guiding groove 340. The said straight guiding groove 340, first sliding groove 341, second sliding groove 342 and third sliding groove 343 together make up a sliding groove to receive the said sliding block 21 therein. One end of the third sliding groove 343 extends to the rear wall 32. And on the inner wall of the said rear wall 32, a hatch 322 is defined towards the straight groove 340, and a first positional pillar 321 is set towards the third sliding groove 343.

With reference to FIG. 1 again, a cover 40 has a top plate 41. At the back end of the plate 41, two clasps 411 are set protruding downwards and forwards into the cover 40. In the middle part of the top plate 41, two recesses 412 are opened in front of the clasps 411.

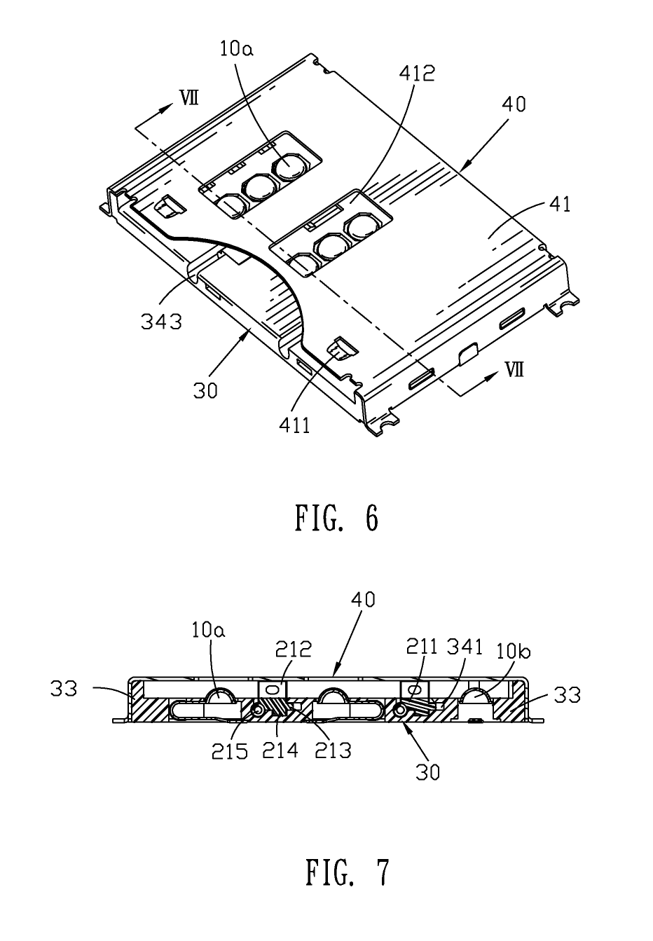

As shown in FIGS. 5 to 7, when the SIM card connector 1 is assembled, the terminals 10a and the fixing terminal 10b are received in the terminal pores 311a and fixing pore 311b separately, and their contact portions 14 expend beyond the surface of the base plate 31 to contact the SIM card 50. The push cam means are received in the sliding grooves, wherein the base portion 211 of the sliding block 21 is received in the straight guiding groove 340, the main body 214 is contained by the second sliding groove 342, the guiding portion 213 is inserted into the first sliding groove 341 by plug from the second slot 344, the projection portion 215 is set into the third sliding groove 343 and the pushing portion 212 expands upwards into the receiving cavity. The top surfaces of the rear wall 32, sidewalls 33 and the said pushing portion 212 are at the same level. The spring 22 is set in the third sliding groove 343 and its one end is hitched on the first positional pillar 321 and resisted on the rear wall 32, while the other end fastened on the second positional pillar 216 of the sliding block 21. The cover 40 shelters the dielectric housing 30 and forms a receiving cavity to contain a SIM card between the top plate 41 of the cover 40 and the base plate 31 of the dielectric housing 30.

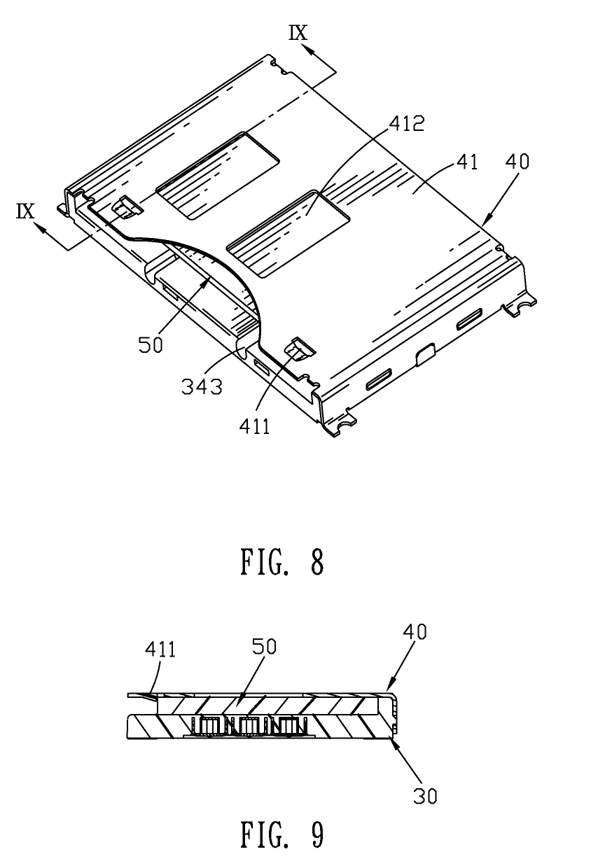

Referring to FIGS. 8 and 9, as the SIM card 50 inserts into the receiving cavity of the SIM card connector 1 from under the said clasps 411, its front end is located against the pushing portion 212 of the sliding block 21 and pushed the sliding block 21 forwards to compress the spring 22. When the SIM card 50 is set in the receiving cavity, the pushing portion 212 is insetted at the hatch 322 in the rear wall 32. The contact portions 14 of the terminals 10a and fixing terminal 10b sustain the SIM card 50 attaching to the cover 40 from its underside and keep it in balance. The back end of the SIM card 50 is against by the two clasps 411. When to remove it out, the SIM card 50 needs to be press down from through the two recesses 412, then it would suppresses the terminals 10a and fixing terminal 10b down and makes itself get divorced from the clasps 411. Under the force provided by the compressed spring 22, the push cam means then drive the SIM card 50 out of the SIM card connector 1.

As described above, a SIM card connector 1 of the present invention achieves the goal of removing card through pressing the SIM card 50 downwards from the recesses 412 of the cover 40. When the SIM card 50 is release from the said clasps 411, the push cam means inside of the SIM card connector 1 would then drive the SIM card 50 out under the force of the compressed springs 22. Thus, the SIM card connector 1 is easy to use and could be embedded in a mobile phone since it takes up only a little space.

Although preferred embodiment of the present invention have been described in detail hereinabove, it should be clearly understand that many variations and/or modifications of the basic inventive concepts herein taught which may appear to those skilled in the present art will fall within the spirit and scope of the present invention, as defined in the appended claims.

What is claimed is:

1. A SIM card connector comprising:
a dielectric housing, having a base plate, a rear wall and two sidewalls extending from the back portion of the base plate and both sides of the base plate respectively, the base plate, the rear wall and the two sidewalls defining a receiving cavity for receiving a SIM card, a plurality of sliding grooves defined on the base plate, and a plurality of terminal pores defined on the base plate too;
a plurality of conductive terminals received in the terminal pores respectively;
a push cam means received in the dielectric housing, the pushing cam means including a plurality of sliding blocks which received in the sliding grooves respectively and a plurality of springs, one end of each spring contacting with the dielectric housing and the other end of the spring contacting with the sliding blocks, each sliding block having a base portion, a pushing portion being defined on one end of the base portion; and
a cover, having a top plate, a plurality of clasps defined on the top plate and a plurality of recesses formed on the top plate too.

2. The SIM card connector as claimed in claim 1, wherein a fixing pore is defined on the base plate and a fixing terminal is received in the fixing pore.

3. The SIM card connector as claimed in claim 1, wherein the sliding grooves are parallel to each other and extend longitudinally.

4. The SIM card connector as claimed in claim 1, wherein each sliding groove includes a straight guiding groove that extends longitudinally.

5. The SIM card connector as claimed in claim 4, wherein the straight groove extends to the rear wall, and a plurality of hatches are defined on the rear wall used to receive the pushing portion of the sliding block.

6. The SIM card connector as claimed in claim 4, wherein a guiding portion protrudes from one side of the base portion of the sliding block, the straight groove has a first sliding groove on its one side, a second slot is formed on the base plate, and the guiding portion inserts into the first sliding groove by the second slot.

7. The SIM card connector as claimed in claim 6, wherein a main body protrudes downward from the same side with the guiding portion of the base portion; a projection portion is defined on the other side of the base portion of the sliding block; a second positional pillar protrudes from the back portion of the projection portion; a second sliding groove is formed below the first sliding groove; a third sliding groove is defined on the other side of the straight groove, the third sliding groove extends to the rear wall; a first positional pillar is formed on the rear wall; the main body is received in the second sliding groove, the projection portion is received in the third sliding groove, the spring is received in the third sliding groove, one end of the spring twines on the first positional pillar and the other end of the spring twines on the second positional pillar.
